(19) United States
(12) Patent Application Publication
(10) Pub. No.: US 2010/0174469 A1
(43) Pub. Date: Jul. 8, 2010

(54) SYSTEM FOR RECALCULATING THE AIR/FUEL MIXTURE IN INTERNAL COMBUSTION ENGINE VEHICLES, AND AN ELECTRONIC DEVICE

(76) Inventors: Diego Vannucci Oliveira, Rio de Janeiro (BR); Linelcio Dos Santos Paula, Sao Jose dos Campos (BR); Nivaldo Nunes Do Nascimento, Sao Jose dos Campos (BR); Debora Alves Dos Santos, Sao Jose dos Campos (BR); Emerson Silva De Oliveira, Sao Jose dos Campos (BR)

Correspondence Address: NIXON PEABODY, LLP, 401 9TH STREET, NW, SUITE 900, WASHINGTON, DC, 20004-2128, US

(21) Appl. No.: 12/524,994

(22) PCT Filed: Jan. 28, 2008
(86) PCT No.: PCT/BR08/00029

§ 371 Date: Mar. 5, 2010

(30) Foreign Application Priority Data
Jan. 29, 2007 (BR) PI 0700549-0

(51) Int. Cl. F02D 28/00; G01M 15/10

(52) U.S. Cl. 701/103; 73/114.72

(57) ABSTRACT

The present Invention is directed to an electronic system that allows for a lower consumption of fuel and emission of polluting gases that are generated after the air/fuel mixture is burned by the internal combustion engine.

### DISCLOSURE OF THE INVENTION

The present invention is directed to an electronic system that allows for a lower consumption of fuel and emission of polluting gases that are generated after the air/fuel mixture is burned by the internal combustion engine.

The electronic central units (ECU) of vehicles are microprocessed and have limitations that become quite evident when one compares a 10 year old ECU with a new one. As the years go by, the central units are becoming quicker and their processing and storing ability is improving more and more, however, despite the huge technological development of the electronic components that make out the circuits of an ECU, the concepts that involve the whole management to calculate the air/fuel rate, the fuel injection time as well as the mass of air and all the parameters that involve the combustion in an internal combustion engine, are the same concepts that can be found in the history of electronic systems developed to be used in vehicles. For the sake of example, we may refer to the book “An Analysis of Internal Combustion Engines” by Edgard Blucher. V.1-Taylor, C.F., 1971: “Similar engines that operate with the same piston average speed values and the same admission and exhaust pressures, admission temperature, cooling temperature, and AC/DC rate will have the same volumetric efficiency within measurable limits.”

Applying this recitation, the automobile industry uses values that have already been used for more than 30 years to calibrate new engines, when similarities between their operations such as, for example, the volumetric efficiency of the engine can be identified. The volumetric efficiency is the maximum amount of mixture allowed for the engine and it is set out and defined for every point of operation (rpm).

Thus, use is made of performance profiles that are experimentally traced in a dynamometric bench and used in all the models of vehicles that use the engine characterized in a laboratory.

Such parameters are stored as tables in the memories of the central units (look-up tables). In general, the use of formulas may be avoided if it is possible to use a look-up table, and the linear interpolations extend the results, but always within the limit of the processing, speed and storage capability that characterizes historically the electronic central units of the vehicles. Further, such tables, despite providing the advantage of reducing the computing time and the ability to eliminate multiplication and division operations, a few overflow, precision and non-linearity issues occupy too much space in the memory (by address) and require a number of assays in dynamometric benches (calibration).

In view of that, in order to attain the best possible performance of all the engines, a process for the field calibration of every vehicle that leaves the factory would be necessary. Such finer calibration of the parameters, that is, the most important parameter in the combustion process which is the control of the air admitted by the admission system to make out the air/fuel mixture, cannot be put into practice before the vehicle goes to the field, and the engine should be exposed to load situations, rotating at mass of air values that are different from those characterized in a laboratory and recorded later in the ECU memory.

The present invention provides a practical fine calibration system that is required in order to attain a better performance of the engine by managing the parameters that involve the combustion, the ECU being used for such management. What cannot be attained in a laboratory because of limitations due to technological or commercial issues may be attained through the present invention. By amplifying the signal that informs the central unit about the pressure of the air that is being admitted (MAP detector), it is possible to expose the engine to a situation different from the one related to operating conditions found in a laboratory and then, despite the limitation of the central units, attain a more precise calculation of the mass of air and, through algorithm characteristics, use values previously traced in a more precise way, attaining in turn a more stoichiometric mixture and consequently reducing the fuel consumption and the emission of polluting gases.

The combustion is a chemical reaction where an oxidant reacts quickly with a fuel to release the energy stored as thermal energy, generally in the form of high temperature gases. Also small amounts of electromagnetic energy (light), electric energy (ions and free electrons), and mechanic energy (noise) are produced during the combustion. Except in the case of special applications, the oxidant is the oxygen from the air.

The conventional fuels (hydrocarbons) are basically comprised of hydrogen and carbon, in the elementary or composite form. The full combustion thereof mainly produces carbon dioxide (CO₂) and water (H₂O). However, small amounts of carbon monoxide (CO) and partially reacted components (gaseous, liquid or solid aerosols) may occur. Most of the conventional fuels also contain small amounts of sulphur (that is oxidized as sulphur dioxide (SO₂) or sulphur trioxide (SO₃) during the combustion), besides non-combustible substances such as mineralized matter (ash), water, and inert gases.

The combustion rate is determined by the type of fuel and depends on:
the chemical reaction rate between the fuel and the oxygen,
the rate the oxygen is supplied to the fuel (mixture of air and fuel),
the temperature in the combustion site.

The basic function of the ECU is to dose the required amount of fuel for the best possible burning in the combustion. The control of the fuel is not as important as the control of the air. The control signals of the fuel dosing system (ECU) are either obtained from the air flow (directly) or from a condition of the engine that reflects the air flow (indirectly).

There are several ways to generate the signals that will control the fuel dosing system. Generally, they are classified into two groups:
Direct methods for measuring the mass of air flow rate to the engine (mass-density);
Indirect methods from the operational conditions of the engine (speed-density).

The mass-density method uses an air flow detector (MAP detector) that it is assembled at the inlet of the admission chamber. Thus, quite a precise measurement of the mass of air admitted by the engine is attained. However, the cost and maintenance thereof are too disadvantageous. Despite being precise, this method still needs to measure the air pressure (MAP detector), in order to find the density of the admission air that influences directly the calculation of the mass of air that will be part of the air/fuel mixture.

The speed-density method uses several variables to attain the load of admission air. Such variables are: temperature detector, engine rpm count, volumetric efficiency and air pressure. The cost is much lower, but in order to obtain relatively precise measurements of the admitted mass of air it is necessary to analyze the engine in a dynamometric bench, and the method should be practically “customized” for each type of engine.

In view of the fact that these methodologies have such characteristics, the present invention may be realized within the limitations of the methodology. In the event of mass-density, it may be possible since, despite the fact that the measurement of the mass of air is a direct measurement, the final calculation of the mass of air requires other measurements in order to compose the result. Also in the event of speed-density, since the calculation is made by using indirect measurements. The invention measures accurately the pressure of the air (MAP detector) that is admitted, using either the mass-density method or the speed-density method.

Most of the electronic systems for managing the combustion in vehicles use indirect methods for the calculation of the mass of fuel (speed-density), where the air load is a function of several variables, that are:
Signals of the temperature detector—admission air temperature (MAT);
Signals of the pressure detector—admission air pressure (MAP);
Value of the volumetric efficiency—already a value calculated from a rate obtained by indirect methods;
Rotation of the engine in rpm.

Through these signals, it is possible to obtain the mass of the admission air that is calculated by the ECU, and then the mass of fuel is obtained, and in turn the time the injecting nozzles are open to launch the fuel into the combustion chamber together with the admission air. The following formulation shows the calculation of the mass of fuel and the injection time.

Q_{comb}=QₐᵢᵣA/F_{stoich};

T_{average inj}=Q_{comb}×Gain×(1±KO_{2 average});

wherein:
Q_{comb}=mass of fuel;
Qₐᵢᵣ=mass of air;
A/F=Stoichiometric rate (air/fuel);
T_{average inj}=average injection time;
KO₂=Lambda factor;

The lambda factor may be added to the mass of fuel formula in order to function as a compensator, and thus the formulation is:

Q_{comb}=Qₐᵢᵣ/A/F_{stoich}=Qₐᵢᵣ/A/F_{stoich}×K=Qₐᵢᵣ/A/Fₘᵢₓₜᵤᵣₑ;

T_{average inj}=Q_{comb}×Gain×(1±0%).

Thus, it can be seen that the mass of air influences the calculation of the mass of fuel directly, thus modifying the stoichiometric rate of the mixture and, since the signal of the MAP detector influences directly the calculation of the mass of air, the result of any modification of this signal is a new calculation of the mass of air and consequently of the mass of fuel.

Since the teachings of present invention show that the influence attained is due to a new calculation and that the MAP detector is the central point of the development, it is possible to prove that the electronic device influences the ECU to attain the fuel economy and less emission of gases.

The importance of the combustion derives from its characteristic of exothermic reaction that remains at a high rate after it is initiated. With this, it propitiates the formation of a thermal “potential difference”, thus originating thermodynamic processes. Further, as a thermo-chemical process, it is essential to a number of industrial and home processes such as cooking and water heating.

The fuel reacts with the precise amount of oxygen required to oxidize all the carbon, hydrogen and sulphur present in the fuel as CO₂, H₂O, and SO₂. Consequently, the exhaustion gas does not contain any incompletely oxidized component and unreacted oxygen (that is, no carbon monoxide and no additional air or oxygen). The percentage of CO₂ contained in the combustion products is the maximum percentage that may be attained, and is designated as stoichiometric CO₂, final CO₂, or maximum theoretical percentage of CO₂.

In practice, the stoichiometric combustion does not occur frequently, due the improper mixtures and finite reaction rates. In order to attain higher economy and safety, most of the combustion equipment should operate with an excess of air. This assures that the fuel is not wasted and that the combustion is completed, in spite of the variations in the properties of the fuel and the fuel and air feeding rates. The amount of additional air to be supplied depends on:
the variations expected in the properties of the fuel and the fuel and air feeding rates;
the application of the equipment; and
the control requirements.

If only “theoretical air” is used, there is a great possibility of not burning the fuel completely (there will be the formation of CO instead of CO₂) and consequently the amount of heat released will be lower.

The purpose of the ECU in vehicles is to manage this excess of air in order to attain the so-called optimum excess of air, a concept whose purpose is to use only the additional amount of air required to attain the complete combustion. However, in practice we can find systems with limitations for this control and always a margin of improvement in the process for determining the optimum excess of air. There are some difficulties in analyzing and attaining such optimum excess of air, since this excess of air affects the efficiency and the emission levels in different and antagonistic ways.

Therefore, nowadays we can find ECU's in the market that provide a limited control of the excess of air in order to get a performance of the engine as close as possible to the optimum performance, but it is hampered by the need to attain more precise values, since this process requires a long processing time, customized calibration and a large memory space. Thus, a balance between power, consumption and emission is searched for.

Theoretically, the amount of such excess depends on a number of factors, but for combustible oils an excess of 15 to 20% is commonly used. By using this excess we would have then a full combustion, but the control of fuel consumption and emission of gases will not reach the highest efficiency.

In the present invention, the electronic device may influence the ECU in a very simple way by providing a different pressure value that will change the calculation of the admission air mass and show through the lambda sensor that new amounts of air/fuel are more suitable by using a lower percentage of air access than the one commonly used.

For a maximum efficiency, the combustion with a low excess of air is desirable.

The function of the lambda sensor is to inform the central unit if the burning of the mixture is closest to the stoichiometric value. If the burning is within pre-defined standards, the central unit adopts the air and fuel values that theoretically show the best situation of efficiency to fulfill the power, consumption and emission requirements.

Since the lambda sensor is the crucial factor to attain the best efficiency rate that is cited previously, when the device developed influences the ECU the lambda sensor itself informs the ECU that the new calculation is better than the one used previously, even if the influence is provided in order to “force” a new calculation of the ECU and attain mass of air values that usually would not be attained in practice. But, since the lambda sensor informs that the mixture is the most correct, the ECU starts to adopt the new values as real and more efficient. And this really happens in practice, thus attaining an expected fuel consumption economy.

In alcohol or gasoline propelled engines, the production of movement starts when the fuel is burned in the combustion chambers. Such chambers contain a cylinder, two valves (one admission valve and one exhaust valve), and a spark plug. The piston that runs inside the cylinder is connected to the connecting rod that pivots with the crankshaft. When the crankshaft rotates, it makes it possible to transfer the movement to the wheels through the vehicle transmission system.

The present day engines use electronic systems that regulate with great precision the amount and content of the mixture introduced into the cylinders, known as electronic injection.

To improve the output of the engines, they usually operate with some cylinders. In a four cylinder engine, when one of the cylinders is aspirating, the second one is compressing, the third one is exploding and the last one is exhausting.

If the engine is stopped, the first movements of the pistons are carried out by an electric motor, known as starting motor. After the first explosions of the fuel, the starting engine is turned off and the pistons start to operate in cycles, like the ones that have been described.

When the vehicle is started, the pistons of the engine move up and down. In the descending movement, an aspiration (vacuum) is produced in the admission chamber, which aspirates the air from the atmosphere that passes the air flow meter and choke valve towards the cylinders of the engine. The air flow meter informs the command unit about the volume of air admitted.

The electronic command unit (ECU), in turn, allows the injection valves to inject the optimum amount of fuel for the volume of air admitted, thus generating the perfect air/fuel rate that is called mixture. The more suitable the mixture, the higher the output and economy, and the lower the emission of polluting gases.

The injection systems are basically comprised of detectors and actuators:

Detectors—Components that are installed at several points of the engine and are used to send information to the command unit. For example: temperature detector.

Actuators—Components that receive information from the command unit and operate in the feeding system by varying the volume of fuel that the engine receives. For example: engine idle actuator.

To control the engine while keeping the performance and the output at optimum levels, the electronic command unit collects information from several detecting components that are strategically installed. With such data, it calculates the injection time (time the injecting valves are open) and the ignition angle of advance for each work regimen of the engine.

When the ignition key is turned on (without starting the engine), the ECU is fed, turns on the diagnosis lamp and activates the electric fuel pump for a few seconds, for the purpose of pressurizing the feeding system.

At this very moment, it issues a voltage of approximately 5 volts CC to most of the detectors of the system and starts receiving the signal characteristic of each one of them (water temperature, pressure at the admission chamber, air temperature, position of the choke valve, etc).

During the starting operation and with the engine on, it receives a signal from the rotation detector. While the electronic command unit captures this signal, it maintains the electric fuel pump activated and control the injecting valve(s), the ignition coil and the idle rotation.

Based on the signal of the detectors, the ECU still controls the cold starting system (alcohol propelled vehicles), the cooling fan, the disconnection of the clutch from the air conditioning compressor, etc.

Most of the electronic command units are provided with a self-diagnosis system, so they may detect several anomalies. When this happens, the ECU records a failure code in the memory thereof, turns on the diagnosis lamp and activates the RECOVERY emergency procedure.

There is a number of ways to improve the efficiency of an internal combustion engine concerning both the reduction of fuel consumption and the reduction of emission of gases. But only a few or quite a few are commercially viable.

Any and all changes in a vehicle have a very strong impact on the market prices and therefore new implementations should be well examined in order to attain the lesser possible cost and thus be commercially viable.

In view of that, the concept used in the present invention was to search an improvement focused on the ECU, where the result of the optimization (improvement) is a change in the calculation of the fuel that is performed by the ECU.

The ECU calculates the amount of fuel to be injected by the injecting nozzles, as a function of the amount (mass) of air that is being admitted by the admission chamber of the vehicle. There is a formula that regulates this rate (air/fuel). This formula has a relationship called stoichiometric rate.

Said stoichiometric rate states that ideally a combustion should have a specific amount of fuel for a certain mass of air that is being admitted. This rate for the alcohol is 8.65 parts of air to 1 part of fuel; for the gasoline (with the addition of 22% anhydrous alcohol) the rate is 13.4 parts of air to 1 part of fuel. This rate is also called stoichiometric mixture.

The stoichiometric mixture is the mixture where the air+fuel rate is ideal so that a full combustion takes place. Theoretically, it would be the reason why an engine containing same would exhibit its maximum power, however, in practice this does not happen, being necessary to use of a mixture with an air/fuel rate lower than the stoichiometric mixture. The use of this mixture in an excess of fuel, with which can be attained the maximum power, is then necessary, because of the vaporization of the mixture and the waste gases of the combustion of the previous cycle that join this new mixture. At the cruise speed of the engine, the predominant factor is the fuel economy, therefore, in this condition the title of the air/fuel mixture should be higher that the stoichiometric value, that is, the combustion takes place in an excess of air. In these two previous examples, it can be seen that the air/fuel rate may oscillate around the stoichiometric value, depending on the engine operating regimen. The lambda (λ) factor of the mixture is usually defined as the reason between the real air/fuel mixture and the stoichiometric air/fuel mixture.

$$λ = \frac{{AF}_{real}}{{AF}_{s}}$$

### Rich Mixture

The mixture is deemed to be rich when the real air/fuel rate is lower than the stoichiometric air/fuel rate, therefore, when λ<1:

$$λ = \frac{{AF}_{real}}{{AF}_{s}} < 1$$

The drawback of the rich mixture is that it provides an incomplete combustion, due to the lack of oxygen. Thus, there will be a formation of carbon deposits in the chamber, rings, valves and electrodes of the spark plug, thus hampering the functioning of the engine. Another disadvantage is the increased fuel consumption of the engine. The advantage is that the temperature inside the fuel chamber is lower when this rich mixture is used.

### Poor Mixture

The mixture is deemed to be poor when the real air/fuel rate is higher than the stoichiometric air/fuel reason, therefore, when λ>1:

$$λ = \frac{{AF}_{real}}{{AF}_{s}} > 1$$

When a poor mixture is ignited, due to the excess of oxygen, the temperature of the flame is very high. This temperature rise may cause an overheating in parts of the engine, mainly in the exhaust valve, and also may burn same.

In the ECU, the verification if the mixture is rich, poor or very close to the optimum stoichiometric value is made by a detector called Lambda Probe that is located in the exhaust pipe of the engine. The Lambda detector is a “Watch dog” or a “feedback” of the system; as a matter of fact, it is the last stage of the process. Its function is to inform the ECU that the calculation made is correct or as close as possible to the optimum calculation (stoichiometric mixture).

Thus, the ECU generates a better MAP detector containing these values that are recorded in the memory of the ECU so that they may be used the next time the vehicle is started.

So that the ECU can make the calculation of the mass of fuel, it needs to be informed about some parameters that come from the detectors placed in the engine.

They are:
MAP detector;
Detector of the position of the choke or electronic pedal;
Engine temperature detector;
Engine rotation detector;
Oxygen detector (Lambda Probe);
Water temperature detector.

In the present invention, the MAP detector and the detector of the position of the choke or electronic pedal are outstanding.

In order to attain the improvement, we use information from the MAP detector.

MAP detector—(Manifold Absolute Pressure)—The manifold absolute pressure in the admission chamber informs the ECU about the pressure change inside the admission chamber in view of the load regimen and the rotation of the engine, that is, information about the pressure that the air aspirated by the engine is submitted to.

Since the MAP informs the pressure of the aspirated air, the ECU is able to calculate the mass of air that is being admitted, through the density of the air, and in view of this value it injects an amount of fuel through the actuator that is called fuel injecting nozzle. The ECU determines the time each nozzle is open and then injects the most suitable mass of fuel of air in view of the amount of air that is being admitted.

After this process, the Lambda Probe detector measures the level of oxygen in the outlet of the exhaust pipe and informs the ECU if the mixture is as close as possible to the optimum one.

The present invention is based on a better control of the amount of air that is being admitted into the chamber. By using the concept that in the real combustion an excess of air is required so that it may have the best possible combustion, a device was developed that influences the ECU to change the calculation of the best proportion of the air/fuel mixture.

With this concept of changing the calculation of the air/fuel mixture so that a reduction of fuel consumption and a reduction of emission of gases can be attained for certain, the air/fuel rate should be changed, either in the mass of air or the mass of fuel.

Since the ECU calculates the time the fuel injecting nozzles are open according to the information from detectors in the vehicle, the only way to improve the air/fuel mixture by turning same as close as possible to the stoichiometric rate is to influence the mass of air that is being admitted in the chamber.

The detector that informs the ECU about the mass of air that is being admitted is the MAP detector. Since we have that to change the measurement of the mass of air, the solution was to capture the signal output by the MAP detector and amplify same in order to inform the ECU that a change occurred in the measurement of the absolute pressure inside the chamber and then force the ECU to make a new calculation of the mixture and generate new command signals for the actuators present in the engine in order to “learn again” and reorganize the operating parameters of the engine, thus using the best MAP present in the memory or the best stretch of the MAP (table recorded in the memory of the ECU) that is recorded in the memory of the ECU and is used every time the vehicle is started.

So that this MAP may be recorded and accepted as the best one generated, the Lambda Probe detector should inform the ECU that the mixture calculated and used for the combustion is the most suitable and closest to the optimum stoichiometric rate (λ=1).

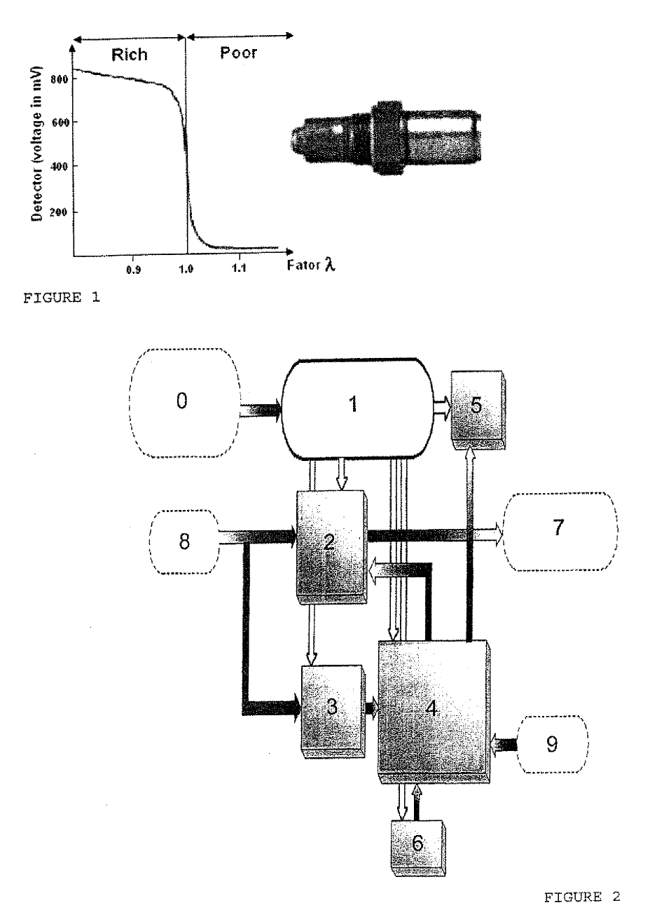

The graphic in FIG. 1 shows the Lambda factor wherein the signal of the Lambda probe is used to determine if the burnt mixture is rich (excess of fuel) or poor (excess of air). This way, the command unit always keeps the engine operating with the correct mixture.

To prove the concept demonstrated, an electronic device was developed that comprises a microcontrolled electronic circuit that receives the signal (DC level) from the MAP detector and amplifies said signal, sending the new amplified signal to the ECU.

The electronic device uses low-cost state of the art microcontrollers, within which a firmware that improves the performance of the ECU is embedded, making it possible to reduce the fuel consumption and correspondently the emission of gases.

The electronic device was conceived with reduced dimensions (40×40×15H) mm; its weight is lower than 50 g. The device is located next to the ECU of the vehicle.

The signal changed for the device means that a different pressure level is being sent to the ECU. This new pressure measurement provides a new calculation, generating new commands for the actuators located in the engine of the vehicle; more directly when the opening time of the fuel injecting nozzles is changed.

The ECU informs the injector nozzles about a new opening time and thus a new amount of mass of fuel. For the stepped engine for the position of the choke “by pass”, the ECU informs a new opening degree in order to correct the pressure inside the admission chamber.

The electronic device was developed having in mind that its operation should to be the quite simple, while being provided with the maximum safety possible regarding the protection of the circuit and the technology used.

Thus, the circuit is provided with hybrid characteristics of the technology applied. It is provided with analog, digital and microcontrolled characteristics through the development of an inner routine (firmware) of the microcontroller.

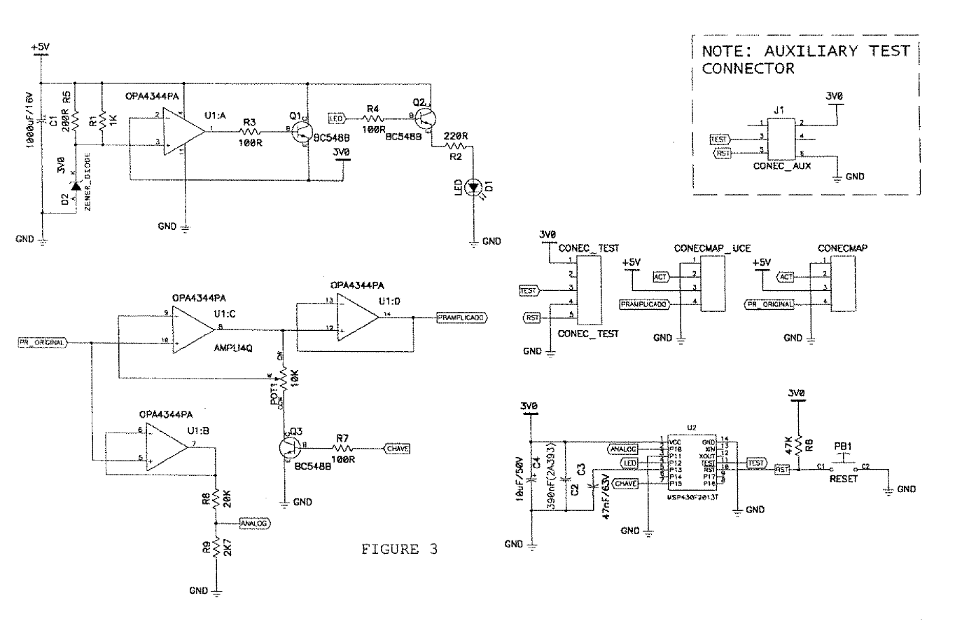

Thus, FIG. 2 illustrates a flowchart of the functional blocks of the circuit, as described below, while FIG. 3 illustrates the electric scheme thereof.

The functional blocks of the circuit are:

Feed Voltage Regulating Circuit DC/DC (1): It receives a 5 volt DC voltage signal from the ECU (0) and sets this voltage to 3.3 volt DC in order to feed all the functional blocks of the circuit.
Circuit that amplifies the signal of the MAP detector with variable gain (2): The amplifying circuit receives the signal from the MAP detector at a DC level (8) and amplifies said signal to the gain limit determined through a gain adjustment meter, by sending the amplified signal to the ECU inlet connector (7). So that the amplification may be carried out, it is required to receive the command that triggers this process. This command comes from the microcontroller.
Analog Level Circuit Detector (3): It detects the analog level of the input signal of the amplifier in order to provide a precise measurement in the fluctuation of the signal and informs the microcontroller about the status of the signal, thus generating the command that activates the amplifying circuit to start the process.
UDC—Microcontrolled Digital Unit (4): The unit is provided with a cheap digital microcontroller (9) the function of which is to analyze the analog level of the signal to be amplified and generate the command that activates the amplifier. This process should be precise and performed at the right time so that a perfect synchronism between the input signal, the amplified signal and the time it is sent to the ECU may be attained. The analysis of the process for generating the command for amplifying and detecting the level is carried out inside the microcontroller by using a dedicated firmware.
Operation Status Circuit (5): This circuit receives a signal from the microcontroller that can be displayed through a LED (Light Emitting Diode) indicating that the amplifier is on, thus operating and carrying out the amplification at the right time.
RESET Circuit (6): Its function is to generate a RESET pulse to the microcontroller so that the amplification process may be reinitialized at any time due to failure or regular process restart.

In tests conducted at different measuring labs, inter glia: Laboratory of the Federal University of Rio de Janeiro (UFRJ) 2004, Multi Laboratory (Porshe/Mazda/Mitsubishi) 2005, and Magneti Marelli Laboratory (São Paulo), the operation in gasoline propelled engines was essayed. The reports issued by these labs enjoy credibility all over the world, mainly the Magneti Marelli report that evidences a 5.6% economy in fuel consumption (gasoline) and CO₂ reduction at the same ratio.

The present invention deals with, amongst other factors, the correction of the calculation regarding the use of the best MAP or parts thereof, to be applied to the vehicle, thus attaining a better performance in the reduction of fuel and emission of gases.

This technology is applied to internal combustion engines that use gasoline, alcohol, or a mixture of both (Flex Fuel). Since the principle of the combustion always uses an air/fuel mixture, the technology may also be developed for the Diesel cycle, GNV and aviation kerosene. For Diesel engines, the reduction in the emission of gases will be even higher. In the case of aeronautical application, the highest gain will be the economy in the fuel consumption.

The electronic concept of the device developed uses electronic components found in the market and a technology applied to the automotive sector.

In the automotive sector there is a standard of connections to connect the several components that make out the electronic system that controls the engine of the vehicle. However, the connections vary from manufacturer to manufacturer and therefore the external connections of the device should be adjusted according to:
the model of the vehicle;
the year of manufacture;
the manufacturer.

In none of the cases the adequacies eliminate the characteristics of the patent, since the electronic circuit will be the same.

Another aspect of the topology of the electronic conception of the hardware is that semiconductors and connections may be replaced with similar ones, without losing the functionality of the developed circuit.

The electronic device is a controllable amplifier that is able to amplify to a percentage of 100% of the input value. This amplification is activated by an authorization from the microcontroller that monitors the signal coming from the MAP detector, and the amplification is terminated only after the signal of the MAP detector indicated that the detector is on and that the vehicle was started so that the first measurement of the admission chamber pressure may be made. In the event the detector is not operating, it sends a signal that will be filtered by the circuit because it is not a valid signal. This signal has a DC level.

So that the optimization is carried out, the amplifier receives the signal from the MAP detector, the first measurement is done as soon as the engine is started, and amplifies the signal at a level higher than 30% of the received value. Thus, the ECU receives the signal of a pressure 30% higher than the real value.

From this moment on, in view of technological limitations of the ECU already described, the methodology of indirect determination of the mass of air, the ECU calculates the mass of air and informs which mass of fuel is the most suitable for the air/fuel rate to burn, but in reality the information about the pressure to the ECU is higher than the real value. Theoretically, this would cause an incorrect combustion and the Lambda detector would show an inadequate burn with an inadequate stoichiometric value. This only happens in the first cycle and then it starts informing that the mixture is suitable. The explanation for this fact is that the ECU shows an amount of fuel calculated from a value of mass of air as a function of an amplified pressure signal, but the real pressure is lower than 30%. At this time, the ECU tries to correct “the changed value” informed through the Lambda detector signal, indicating that the burn is more pollutant, and informs the air admission control actuators that the air flow should be corrected in order to have a combustion with a stoichiometric mixture again.

When the ECU makes this correction through the actuators, the pressure within the admission chamber may be reduced and thus the mass of air may be corrected. Since the value of the fuel mass is changed only after a new mixture is burned, and after receiving the information from the Lambda detector that it is a stoichiometric mixture, the new mixture gets closer to the stoichiometric value that is informed by the Lambda detector and then, as previously described, the ECU adopts a new stretch of the combustion value MAP, where more suitable air excess values as a function of each load required for the engine are used.

The influence of the electronic circuit on the ECU, by amplifying the signal, was limited only once. In the following way:

After the actuator corrects the pressure in the admission chamber by turning the signal measured by the MAP detector 30% lower, the amplifier starts informing a real pressure value inside the admission chamber again. This happens because the amplifier is linear, that is, it amplifies 30% the value that is found at the inlet of the amplifier. Since the input signal was corrected (diminished) in 30% by the actuators, the new signal sent to the ECU turns out to be the “original one”, showing the value of the pressure in a real way, but now with a new mass of fuel value. This mass of fuel is obtained because the ECU changes the opening time of the fuel injecting nozzles.

After the correction, the amplifying starts amplifying whatever is present at the inlet, but with a reduced value in the percentage of the stipulated amplification, since the actuators had made said correction, reducing the air pressure measured, and consequently the signal that the electronic device will amplify. From this moment on, the starts turns out to be a signal follower for the ECU and will change the amplification range only if it is configured to amplify more than 30% of the initial gain.

It is this whole process that makes it possible to attain a fuel economy and consequently a reduction in the emission of CO₂ proportional to the fuel economy, because the most stoichiometric mixture possible provides a full combustion with less excess or air and a small power gain of the engine. This small power gain is also evidenced in the same report that shows a 5.65% economy in the fuel consumption in the laboratory.

Due to the characteristics of the previously described process, in the field we were able to obtain fuel consumption reduction values higher than those obtained in the laboratory.

The reduction range obtained in the field is between approximately 5 and 20%, depending on the following characteristics of the vehicle:
Model of the vehicle;
Year of Manufacture;
Manufacturer.

Due to the constructive characteristics of the electronic device, it is possible to provide a stepped amplification of the signal. For example: 5% to 5% amplification, and thus check the degree of economy attained.

This economy process may be attained based on the description of the previously described concepts.

The system developed may be used in any vehicle provided with electronic fuel injection manufactured as of 1990.

1-4. (canceled)

5. A system for recalibrating the calculation of the air/fuel mixture in internal combustion engine vehicles, wherein said system captures the information coming from the MAP detector, modifies this signal in order to inform the ECU that there was a change in the measurement of the absolute pressure inside the chamber and thus forces the ECU to make a new calculation of the mixture and generate new command signals for the actuators present in the engine in order “to learn again” and reorganize the operating parameters of the engine, thus using the best MAP present in the memory or the best stretch of the MAP that is recorded in the memory of the ECU; wherein the Lambda probe detector informs the ECU that the mixture calculated and used for the combustion is the most suitable and closest to the ideal stoichiometric rate (λ=1), so that the command to use the best MAP or the best stretch of the MAP may be recorded in the memory.

6. An electronic device, comprising a microcontrolled electronic circuit that receives a signal (DC level) from the MAP detector, within which a firmware that improves the performance of the ECU is embedded; wherein the signal changed by the device means that a different pressure level is being sent to the ECU, forcing a new calculation and generating new commands for the actuators; more directly when the opening of the fuel injecting nozzles is changed.

7. The electronic device according to claim 6, wherein the circuit is provided with hybrid characteristics of the technology applied, either analog, or digital and microcontrolled through the development of a routine (firmware).

8. The electronic device according to any of claim 5, wherein the circuit is configured by the following functional blocks:
Feed Voltage Regulating Circuit DC/DC (1) that receives the feeding signal from the ECU (0);
Circuit that amplifies the signal of the MAP detector with variable gain (2) that receives the signal from the MAP detector at a DC level (8), by sending the amplified signal to the ECU inlet connector (7);
Analog Level Circuit Detector (3);
Microcontrolled Digital Unit (4) that captures the information from the microcontroller programming connector (9);
Operation Status Circuit (5);
RESET Circuit (6).

9. The electronic device according to any of claim 6, wherein the circuit is configured by the following functional blocks:
Feed Voltage Regulating Circuit DC/DC (1) that receives the feeding signal from the ECU (0);
Circuit that amplifies the signal of the MAP detector with variable gain (2) that receives the signal from the MAP detector at a DC level (8), by sending the amplified signal to the ECU inlet connector (7);
Analog Level Circuit Detector (3);
Microcontrolled Digital Unit (4) that captures the information from the microcontroller programming connector (9);
Operation Status Circuit (5);
RESET Circuit (6).
